(19) United States
(12) Patent Application Publication
(10) Pub. No.: US 2026/0290199 A1
(43) Pub. Date: Sep. 24, 2026

(54) WORK MACHINE DISPLAY SYSTEM AND WORK MACHINE DISPLAY METHOD

(71) Applicants: KOMATSU LTD., Tokyo (JP); NATIONAL INSTITUTE OF ADVANCED INDUSTRIAL SCIENCE AND TECHNOLOGY, Tokyo (JP)

(72) Inventors: Koji OKUDA, Tokyo (JP); Yukinori MATSUMURA, Tokyo (JP); Mai OTSUKI, Tsukuba-shi (JP)

(73) Assignees: KOMATSU LTD., Tokyo (JP); NATIONAL INSTITUTE OF ADVANCED INDUSTRIAL SCIENCE AND TECHNOLOGY, Tokyo (JP)

(21) Appl. No.: 19/490,952

(22) PCT Filed: Jun. 14, 2024
(86) PCT No.: PCT/JP2024/021697

§ 371 Date: Dec. 8, 2025

(30) Foreign Application Priority Data
Jun. 16, 2023 (JP) 2023-099484

(51) Int. Cl. G09B 9/042; G02B 27/00; G02B 27/01; G06F 1/16; G06F 3/01; G09B 9/05

(52) U.S. Cl. CPC G09B 9/042; G02B 27/0093; G02B 27/0172; G06F 1/163; G06F 3/012; G06F 3/013; G09B 9/05; G02B 2027/014

(57) ABSTRACT

A display system accepts input of first operation data from a first operator. The display system simulates a change in posture of a work machine in accordance with first operation data. The display system reproduces an operation performed by a second operator, on the basis of model data including second operation data previously input by the second operator. The display system simultaneously displays a first moving image representing the simulated change in the posture of the work machine and a second moving image representing the reproduced operation performed by the second operator.

### TECHNICAL FIELD

The present disclosure relates to a display system and a display method for a work machine.

Priority is claimed on Japanese Patent Application No. 2023-099484, filed Jun. 16, 2023, the contents of which are incorporated herein by reference.

### BACKGROUND ART

Patent Document 1 discloses a technique for an operator to simulate the operation of a work machine while referencing the operation of the work machine performed by the operator themselves or another operator. The technique disclosed in Patent Document 1 involves replaying a moving image of past operations performed by a remotely operated work machine and performing an operation simulation within an operation environment corresponding to the replay position at which the moving image is stopped.

### CITATION LIST

### Patent Document

Patent Document 1: Japanese Unexamined Patent Application, First Publication No. 2021-103193

### SUMMARY OF INVENTION

### Technical Problem

In a simulation for training, it is required to confirm past operations of the work machine while performing an operation simulation. For example, a beginner-level trainee can efficiently acquire operational skills by operating the work machine in accordance with the operation of an expert-level trainer. Also, for example, an intermediate-level trainee can notice subtle differences in operation by recognizing, in real time, the differences from the operation of the expert-level trainer.

An exemplary object of the present disclosure is to provide a display system and a display method for a work machine capable of easily comparing an operator's operation with another operation, in training for operating a work machine.

### Solution to Problem

According to one exemplary aspect of the present invention, a display system for a work machine: accepts input of first operation data from a first operator; simulates a change in posture of a work machine in accordance with the first operation data; reproduces an operation performed by the second operator, on the basis of model data including second operation data previously input by a second operator; and simultaneously displays a first moving image representing the simulated change in the posture of the work machine and a second moving image representing the reproduced operation performed by the second operator.

### Advantageous Effects of Invention

According to the above aspect, it is possible to easily compare an operator's operation with another operation, in training for operating a work machine.

### BRIEF DESCRIPTION OF DRAWINGS

FIG. 1 A schematic configuration diagram showing a configuration of a training system according to a first exemplary embodiment.

FIG. 2 A block diagram showing a software configuration of a training simulator according to the first exemplary embodiment.

FIG. 3 A flowchart showing a model data creation method according to the first exemplary embodiment.

FIG. 4 A diagram showing an example of a setting data input screen according to the first exemplary embodiment.

FIG. 5 A flowchart (part 1) showing a method for performing training according to the first exemplary embodiment.

FIG. 6 A flowchart (part 2) showing the method for performing training according to the first exemplary embodiment.

FIG. 7 A flowchart (part 3) showing the method for performing training according to the first exemplary embodiment.

FIG. 8 An example of image data when rendering an entire ghost machine according to the first exemplary embodiment.

FIG. 9 An example of image data when rendering only the bucket of the ghost machine according to the first exemplary embodiment.

FIG. 10 An example of image data when displaying the trajectory of the bucket cutting edge of the ghost machine according to the first exemplary embodiment.

FIG. 11 An example of image data when displaying a lever operation of a trainer according to the first exemplary embodiment.

FIG. 12 An example of image data when displaying a gaze of the trainer according to the first exemplary embodiment.

FIG. 13 An example of image data when displaying a side view according to the first exemplary embodiment.

FIG. 14 A diagram showing an example of a trajectory model according to the first exemplary embodiment.

FIG. 15 A flowchart showing a work data evaluation method according to the first exemplary embodiment.

FIG. 16 A flowchart showing a method according to the first exemplary embodiment by which a trainee views evaluation results.

FIG. 17 A schematic block diagram showing a configuration of a computer according to at least one of the exemplary embodiments.

### DESCRIPTION OF EMBODIMENTS

### FIRST EXEMPLARY EMBODIMENT

### Configuration of Training System 1

Hereinafter, preferred exemplary embodiments will be described in detail, with reference to the drawings.

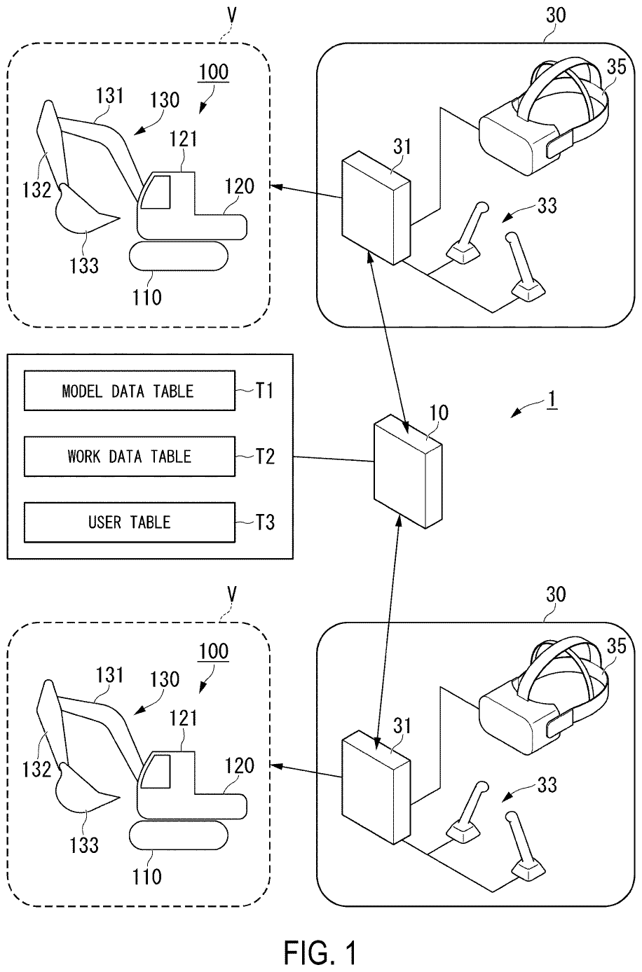

FIG. 1 is a schematic configuration diagram showing a configuration of a training system 1 according to a first exemplary embodiment.

The training system 1 according to the first exemplary embodiment is a system for a trainee, who is an operator unfamiliar with the operation of a work machine 100, to simulate the operation of the work machine 100 while referencing the operation of the work machine 100 performed by a trainer, who is an operator skilled in the operation of the work machine 100. The trainee can be evaluated on their own operation by the training system 1 or the trainer. Both the trainer and the trainee are operators of the work machine 100. In the first exemplary embodiment, the training system 1 is used for training in the operation of a hydraulic excavator, which is the work machine 100. The work machine 100 is not limited to a hydraulic excavators, and may also encompass other types of work machines such as bulldozers, wheel loaders, or forklifts.

The training system 1 includes a data server 10 and one or more training simulator(s) 30.

The data server 10 stores model data and work data used in training. The model data represents the trainer's operation of the work machine 100. The trainee uses the model data as a reference for their training. The work data represents the trainee's operation of the work machine 100. The training system 1 and the trainer evaluate the operation of the trainee based on the work data. The model data and work data include the time series of operation of operation levers, the time series of the posture (joint angles and turning angles of the work equipment) of the work machine 100, and the time series of gaze. Hereinafter, data representing the time series of operation and behavior of the work machine 100, such as model data and work data, will also be referred to as behavior record data.

Specifically, the data server 10 includes a model data table T1 for storing model data, a work data table T2 for storing work data, and a user table T3 for storing authentication data.

The model data table T1 stores model data, a model ID which is an ID (identification information) of the model data, and overview data which indicates the work content reproduced by the model data, in association with each other.

The work data table T2 stores work data, a work ID which is the ID (identification information) of the work data, a model ID of the corresponding model data, evaluation data indicating the evaluation made by the training system 1, and comment data indicating the evaluation made by the trainer, in association with each other.

The user table T3 stores a user ID, a user classification, and authentication information in association with each other. The user classification is either a trainer or a trainee. The authentication information may be, for example, a password.

The training simulator 30 accepts an operation input from the operator, and simulates the behavior of the work machine 100 in response to the operation input. The training simulator 30 generates an image representing the behavior of the work machine 100 and presents it to the operator. Moreover, the training simulator 30 reproduces the behavior of the work machine 100 based on the model data stored in the data server 10, generates an image representing the behavior of the work machine 100, and presents it to the operator.

The training simulator 30 includes a computation device 31, an operation device 33, and a head-mounted display 35. The operation device 33 is an input interface for operating the work machine 100. The operation device 33 according to the first exemplary embodiment includes two operation levers (a right operation lever and a left operation lever). The operation device 33 may differ depending on the type of work machine 100 for which the simulation is performed. The head-mounted display 35 displays an image calculated by the computation device 31. The head-mounted display 35 includes an eye tracker that detects the wearer's gaze and an IMU (Inertial Measurement Unit) that detects the posture of the head-mounted display 35. The computation device 31 simulates the work machine 100 in the virtual space V based on input from the operation device 33. The computation device 31 determines the direction of the gaze in the virtual space V based on the posture of the head-mounted display 35, and renders the simulation results. As a result, the virtual space V is displayed on the head-mounted display 35 in conjunction with the posture of the head-mounted display 35.

### Configuration of Work Machine 100

The work machine 100 includes a traveling body 110, a rotating body 120, and a work equipment 130.

The traveling body 110 supports the work machine 100 so as to be capable of traveling.

The rotating body 120 is supported by the traveling body 110 so as to be capable of rotating about a center of rotation. A cab 121 is provided at the front of the rotating body 120. A rendering camera for rendering the virtual space V by means of the computation device 31 is provided in the cab 121.

The work equipment 130 is supported at the front of the rotating body 120 so as to be able to be driven vertically.

The work equipment 130 includes a boom 131, an arm 132, and a bucket 133 serving as a work tool. For example, the work tool has a blade edge that extends across its width. Other examples of the work tool include front-end attachments such as clam buckets, tilt buckets, tilt rotate buckets, breakers, and grapplers.

The proximal end part of the boom 131 is rotatably attached to the rotating body 120 via a boom pin. In the work machine 100 shown in FIG. 1, the boom 131 is provided in the center portion at the front of the rotating body 120, but the invention is not limited to this configuration, and the boom 131 may be attached offset in the left-right direction. In such a case, the center of rotating of the rotating body 120 is not located on the operating plane of the work equipment 130.

The arm 132 connects the boom 131 and the bucket 133. The proximal end part of the arm 132 is rotatably attached to the distal end part of the boom 131 via an arm pin.

The bucket 133 is rotatably attached to the distal end part of the arm 132 via a pin. The bucket 133 functions as a container for containing the excavated earth.

### Configuration of Training Simulator 30

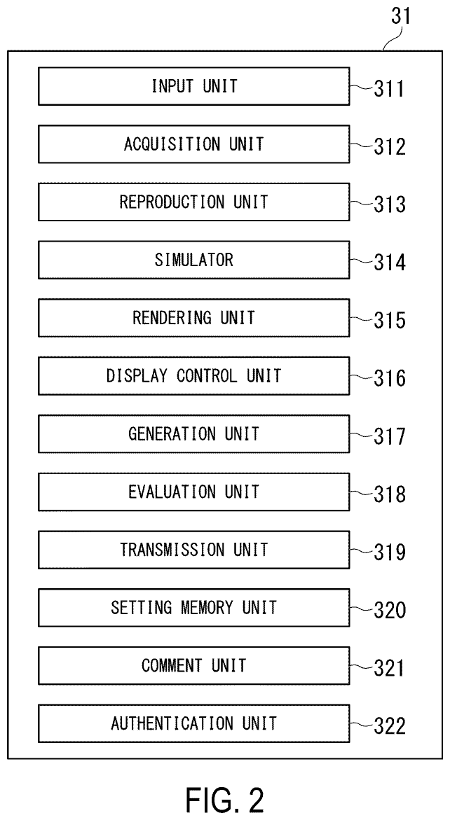

FIG. 2 is a block diagram showing a software configuration of the computation device 31 included in the training simulator 30 according to the first exemplary embodiment.

The computation device 31 included in the training simulator 30 includes an input unit 311, an acquisition unit 312, a reproduction unit 313, a simulator 314, a rendering unit 315, a display control unit 316, a generation unit 317, an evaluation unit 318, a transmission unit 319, a setting memory unit 320, a comment unit 321, and an authentication unit 322.

The input unit 311 acquires operation data of the operation device 33, posture data measured by the IMU of the head-mounted display 35, and gaze data measured by the eye tracker of the head-mounted display 35. The gaze data is represented by a direction relative to the display surface of the head-mounted display 35. It should be noted that by combining the posture data and the gaze data, an absolute gaze direction can be identified. Hereinafter, the gaze data measured by the eye tracker is referred to as primary gaze data, and the gaze data indicating the absolute gaze direction identified from the posture data and the gaze data is referred to as secondary gaze data.

The acquisition unit 312 acquires behavior record data (model data and work data) from the data server 10.

The reproduction unit 313 reproduces the behavior of the work machine 100 based on the behavior record data acquired by the acquisition unit 312. Hereinafter, the work machine 100 reproduced in the virtual space V by the reproduction unit 313 will be referred to as ghost machine 100G. The reproduction unit 313 reproduces the behavior of the work machine 100 by arranging the ghost machine 100G in accordance with the time series of the joint angles of the work equipment 130 and the turning angles of the rotating body 120 included in the behavior record data. It should be noted that the reproduction unit 313 according to another exemplary embodiment may, for example, simulate the behavior of the work machine 100 based on the time-series data of the movement of the operation levers included in the behavior record data, thereby arranging the ghost machine 100G.

The simulator 314 simulates the behavior of the work machine 100 based on the operation data input to the input unit 311. Hereinafter, the work machine 100 simulated by the simulator 314 will be referred to as an avatar machine 100A. The simulator 314 simulates the behavior of the avatar machine 100A by calculating the angular velocities of the rotating body 120 and the work equipment 130 according to the operation amount indicated by the operation data.

The rendering unit 315 renders the ghost machine 100G and the avatar machine 100A and generates image data. The rendering camera in the virtual space is located in the cab 121 of the avatar machine 100A. The rendering camera is directed to face the front of the head-mounted display 35, as indicated by the posture data input to the input unit 311, with the front of the avatar machine 100A as a reference. The rendering by the rendering unit 315 is performed at a predetermined frame rate. Accordingly, the image data generated by the rendering unit 315 is treated as frame images of a moving image.

The display control unit 316 outputs the image data rendered by the rendering unit 315 to the head-mounted display 35.

The generation unit 317 generates behavior record data based on the operation data, posture data, and primary gaze data input to the input unit 311, and the posture of the avatar machine 100A simulated by the simulator 314. Specifically, the generation unit 317 acquires positions and postures of the traveling body 110, the rotating body 120, the boom 131, the arm 132 and the bucket 133 of the avatar machine 100A in the virtual space, based on the posture of the avatar machine 100A simulated by the simulator 314. Each position and posture is represented using a virtual space coordinate system, which is a three-dimensional orthogonal coordinate system that defines the virtual space. The generation unit 317 generates secondary gaze data indicating the direction of the gaze in the virtual space coordinate system based on the positions and postures of the traveling body 110, the rotating body 120, the boom 131, the arm 132 and the bucket 133 in the virtual space, as well as the posture data and the primary gaze data.

The evaluation unit 318 evaluates the operation performed by the trainee based on the difference between the model data acquired by the acquisition unit 312 and the work data generated by the generation unit 317. For example, the evaluation unit 318 calculates distances for the position and posture of the rotating body 120, as well as the posture data and the secondary gaze data, in the virtual space indicated by the model data and the work data. The evaluation unit 318 finds the distances between each of the following time series in the model data and their counterparts in the work data: the positions and postures of the traveling body 110, the rotating body 120, the boom 131, the arm 132, and the bucket 133; the posture data; and the secondary gaze data, thereby calculating a weighted sum of these distances as an evaluation value. In such a case, the closer the evaluation value is to zero, the higher the evaluation. The distance between time series may be calculated using the DTW method.

The transmission unit 319 transmits the behavior record data generated by the generation unit 317, to the data server 10.

The setting memory unit 320 stores setting data of the training simulator 30. The setting data stores: the replay speed of the ghost machine 100G; whether or not to display the ghost machine 100G; whether or not to display the trajectory of the blade edge of the ghost machine 100G's work tool; whether or not to display a side view; whether or not to display the trainer's lever operation; and whether or not to display the trainer's gaze. The setting data can be updated through the trainee's operation. The side view is an image that displays the virtual space from a lateral perspective of the avatar machine 100A. The side view is rendered inside the cab.

The comment unit 321 accepts input of comments for the work data. Comments can be associated with replay timings. Accordingly, the comment unit 321 can be set to display a comment at a predetermined timing during replay of the work data.

The authentication unit 322 authenticates the operator of the training simulator 30 based on the authentication information stored in the data server 10.

### Processing of Training System 1

Upon activation of the training simulator 30, the authentication unit 322 causes the head-mounted display 35 to display a login screen. The login screen displays, for example, an input form for entering a user ID and authentication information. When the operator inputs their user ID and authentication information values on the login screen, the authentication unit 322 acquires authentication information associated with the input user ID from the user table T3 on the data server 10, and verifies the authentication information.

Upon successful verification performed by the authentication unit 322, the display control unit 316 displays a menu screen on the head-mounted display 35.

In the case where the user classification of the operator is a trainer, a trainer menu is displayed on the menu screen for allowing the operator to select either creation of model data or evaluation of work data.

In the case where the user classification of the operator is a trainee, a trainee menu is displayed on the menu screen for allowing the operator to select from among performing training, viewing evaluation results, and changing settings.

### Generation of Model Data

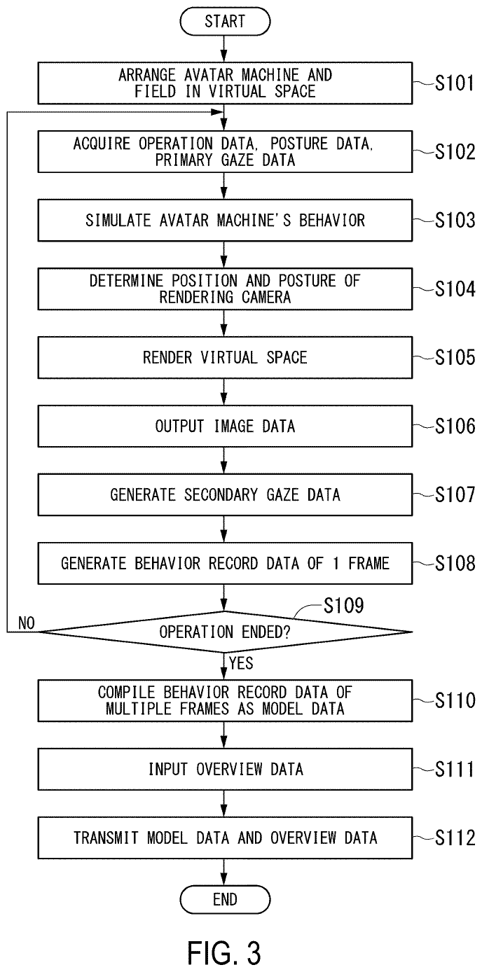

FIG. 3 is a flowchart showing a model data creation method according to the first exemplary embodiment.

As the trainer logs into the training simulator 30 and selects creation of model data on the menu screen, the simulator 314 places the avatar machine 100A in an initial posture and a field in the virtual space (Step S101).

The input unit 311 acquires operation data of the operation device 33, posture data measured by the IMU of the head-mounted display 35, and primary gaze data measured by the eye tracker of the head-mounted display 35 (Step S102).

The simulator 314 simulates the behavior of the avatar machine 100A after a predetermined frame time based on the operation data input in Step S102 (Step S103). At this time, the simulator 314 calculates the positions and postures of the traveling body 110, the rotating body 120, the boom 131, the arm 132, and the bucket 133.

The simulator 314 determines the position and posture of the rendering camera in the virtual space, based on the position and posture of the rotating body 120 and the posture data input in Step S102 (Step S104). The rendering unit 315 renders the virtual space in which the avatar machine 100A is positioned, from the rendering camera determined in Step S104 (Step S105). The display control unit 316 outputs the image data rendered in Step S105 to the head-mounted display 35 (Step S106).

The generation unit 317 generates secondary gaze data indicating the direction of the trainer's gaze in the virtual space based on the position and posture of the rendering camera calculated in Step S104 and the primary gaze data acquired in Step S102 (Step S107). The generation unit 317 generates one frame of behavior record data based on the operation data acquired in Step S102, the posture of the avatar machine 100A calculated in Step S104, and the secondary gaze data generated in Step S107 (Step S108).

The generation unit 317 determines whether or not the operation performed by the trainer has ended (Step S109). Upon determining to end the operation, the trainer performs a predetermined operation on the training simulator 30, such as shifting their gaze to the end button on the screen, to thereby instruct to end the operation. If the operation of the trainer has not ended (Step S109: NO), the processing returns to Step S102, and the simulation of the next frame is performed.

On the other hand, if the operation of the trainer has ended (Step S109: YES), the generation unit 317 compiles the generated behavior record data of the multiple frames as model data (Step S110). The generating unit 317 also accepts input of overview data regarding the model data from the trainer (Step S111). The transmission unit 319 transmits the model data and the overview data to the data server 10 (Step S112). As a result, the data server 10 assigns a model ID to the received model data and records the model ID, the model data, and the overview data in association within the model data table T1.

### Change Settings

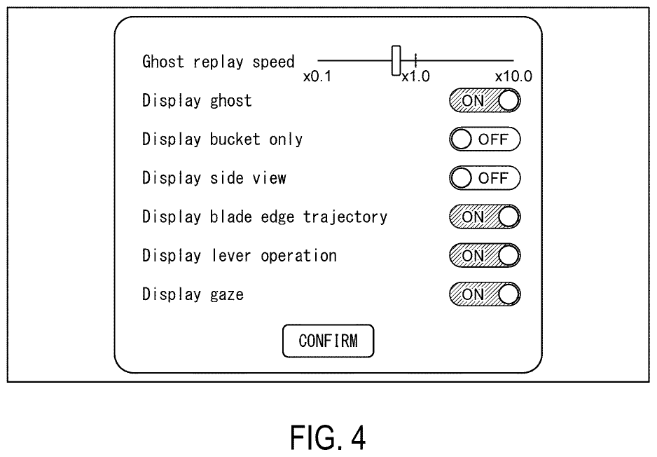

When the trainee logs into the training simulator 30 and selects to change the settings on the menu screen, the display control unit 316 reads out the setting data stored in the setting memory unit 320 and outputs a setting data input screen to the head-mounted display 35. FIG. 4 is a diagram showing an example of the setting data input screen according to the first exemplary embodiment. The input screen includes an input form for the replay speed of the ghost machine 100G, whether or not to display the ghost machine 100G, whether or not to display the trajectory of the blade edge of the ghost machine 100G, whether or not to display a side view, whether or not to display the trainer's lever operation, and whether or not to display the trainer's gaze, as well as a confirm button. The setting data can be updated through the trainee's operation. If the ghost machine 100G display is ON in the input form, a form for inputting whether or not to display only the bucket 133 of the ghost machine 100G is displayed on the input screen. When the confirm button is operated through the operation of the trainee, the setting memory unit 320 updates the setting data in accordance with the value input on the input screen.

### Performing Training

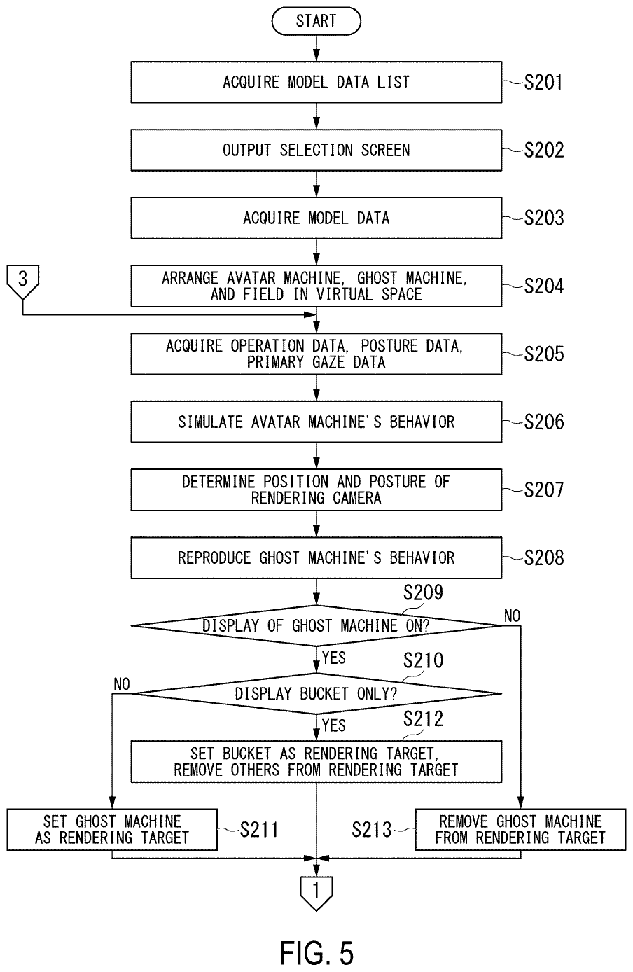

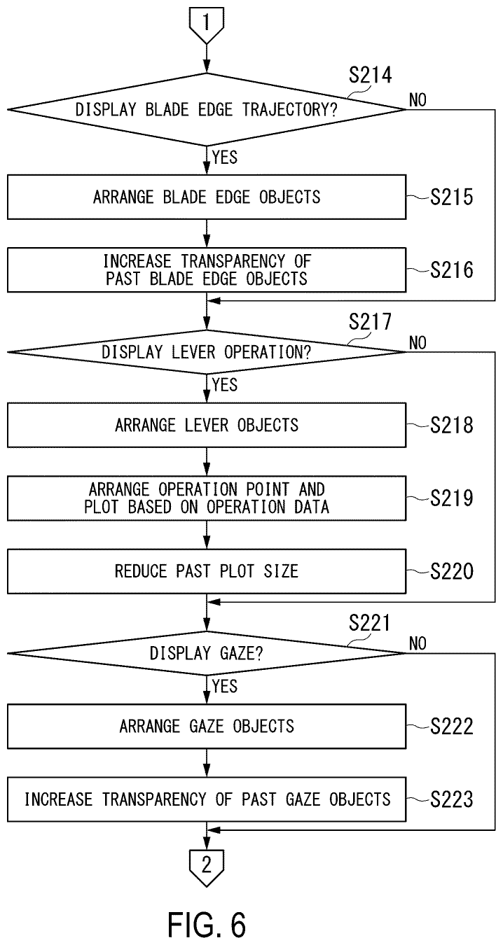

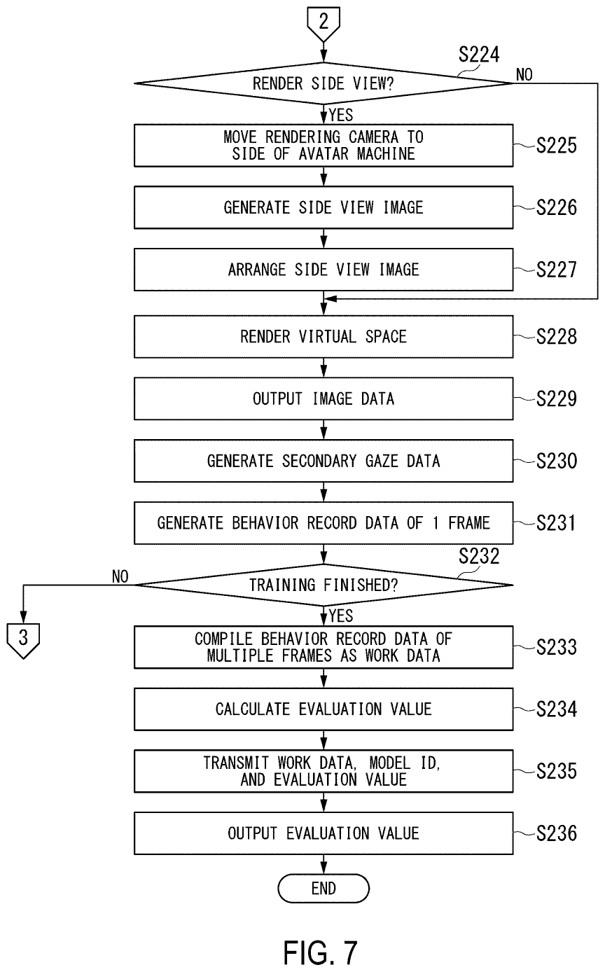

FIG. 5 is a flowchart (part 1) showing a method for performing training according to the first exemplary embodiment. FIG. 6 is a flowchart (part 2) showing the method for performing training according to the first exemplary embodiment. FIG. 7 is a flowchart (part 3) showing the method for performing training according to the first exemplary embodiment.

When the trainee logs into the training simulator 30 and selects to perform training on the menu screen, the acquisition unit 312 accesses the data server 10 and acquires a model data list recorded in the model data table T1 (Step S201). The display control unit 316 outputs a selection screen for selecting one model data from the acquired list to the head-mounted display 35 (Step S202). At this time, the model data list and corresponding overview data indicating the contents of the model data are displayed on the selection screen. The trainee reads the overview data and selects one model data.

The acquisition unit 312 accesses the data server 10 and acquires the model data selected by the trainee from the model data table T1 (Step S203). The simulator 314 places the avatar machine 100A, the ghost machine 100G, and a field, in the virtual space (Step S204). The avatar machine 100A and the ghost machine 100G are arranged to overlap at the same position.

The input unit 311 acquires operation data of the operation device 33, posture data measured by the IMU of the head-mounted display 35, and primary gaze data measured by the eye tracker of the head-mounted display 35 (Step S205).

The simulator 314 simulates the behavior of the avatar machine 100A after a predetermined frame time based on the operation data input in Step S205 (Step S206). At this time, the simulator 314 calculates the positions and postures of the traveling body 110, the rotating body 120, the boom 131, the arm 132, and the bucket 133. The simulator 314 calculates the position and posture of the rendering camera in the virtual space based on the position and posture of the rotating body 120 and the posture data input in Step S205 (Step S207).

The reproduction unit 313 reproduces the behavior of the ghost machine 100G by calculating the posture of the ghost machine 100G based on: the time series of the joint angles of the work equipment 130 and the turning angles of the rotating body 120 contained in the model data acquired in Step S203; and the replay speed of the ghost machine 100G indicated by the setting data (Step S208).

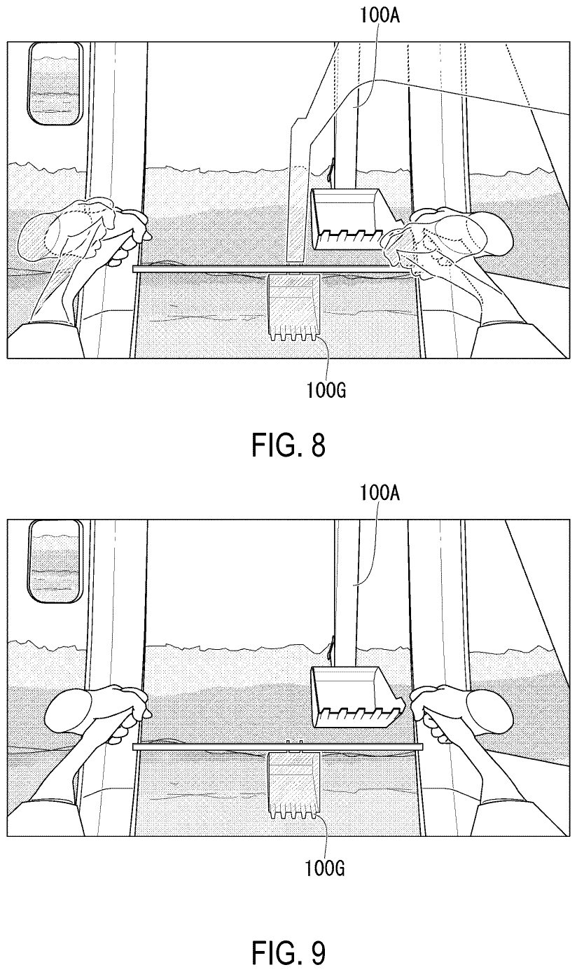

The reproduction unit 313 determines, in the setting data, whether or not the ghost machine 100G is set to be displayed (Step S209). If the ghost machine 100G is set to be displayed (Step S209: YES), the reproduction unit 313 determines, in the setting data, whether only the bucket 133 of the ghost machine 100G is set to be displayed (step S210). If it is not set to display only the bucket 133 (Step S210: NO), the reproduction unit 313 determines all configuration elements of the ghost machine 100G as rendering targets (Step S211). In such a case, the image data is rendered as shown in FIG. 8. FIG. 8 is an example of the image data when rendering the entire ghost machine 100G according to the first exemplary embodiment.

If it is set to display only the bucket 133 (Step S210: YES), the reproducing unit 313 determines the bucket 133 of the ghost machine 100G as the rendering target, and excludes configuration elements of the ghost machine 100G other than the bucket 133 from the rendering target (Step S212). In such a case, the image data is rendered as shown in FIG. 9. FIG. 9 is an example of the image data when rendering only the bucket 133 of the ghost machine 100G according to the first exemplary embodiment.

If it is not set to display the ghost machine 100G (Step S209: NO), the reproduction unit 313 excludes the ghost machine 100G from the rendering target (Step S213).

Next the reproduction unit 313 determines, in the setting data, whether or not the trajectory of the ghost machine 100G's blade edge is set to be displayed (Step S214). If it is set to display the trajectory of the ghost machine 100G's blade edge (Step S214: YES), the reproduction unit 313 generates blade edge objects Obj1 indicating the trajectory of the blade edge and places them at both ends and in the center of the bucket cutting edge 133 of the ghost machine 100G calculated in Step S208 (Step S215). Each blade edge object Obj1 may be, for example, a small sphere. The blade edge objects Obj1 may correspond to, for example, one or multiple points on the blade edge, and each blade edge object Obj1 represents the trajectory of each point. The reproduction unit 313 increases the transparency of the blade edge objects Obj1 generated in the past by a predetermined value (Step S216). As a result, the multiple blade edge objects Obj1 represent the trajectory of the position of the bucket cutting edge 133 over the most recent predetermined period of time, with older positions being displayed with higher transparency. In another exemplary embodiment, the reproduction unit 313 may change the size of the blade edge objects Obj1 instead of the transparency. Blade edge objects Obj1 with transparency exceeding a predetermined threshold value may be removed from the virtual space. For example, blade edge objects Obj1 with transparency exceeding a predetermined threshold value need not be displayed. In such a case, the image data is rendered as shown in FIG. 10. FIG. 10 is an example of the image data when displaying the trajectory of the bucket cutting edge 133 of the ghost machine 100G according to the first exemplary embodiment. The multiple blade edge objects Obj1 are rendered as curved lines representing the trajectory of the blade edge.

If it is not set to display the trajectory of the blade edge of the ghost machine 100G (Step S214: NO), the reproduction unit 313 does not place the blade edge objects Obj1 in the virtual space. The blade edge objects Obj1 may have different colors at the left end, center, and right end of the blade edge. Any one of the left end, center, or right end of the blade edge may be rendered as the blade edge object Obj1. The blade edge object Obj1 may also be represented as a strip-shaped trajectory of a line segment extending from the left end to the right end of the blade edge.

Next, the reproduction unit 313 determines whether or not it is set in the setting data to display trainer's lever operation (Step S217). If it is set to display lever operation (Step S217: YES), the reproduction unit 313 places lever objects Obj2 at positions a predetermined distance away from the position of the rendering camera determined in Step S207 in the direction in which the rendering camera is facing (Step S218).

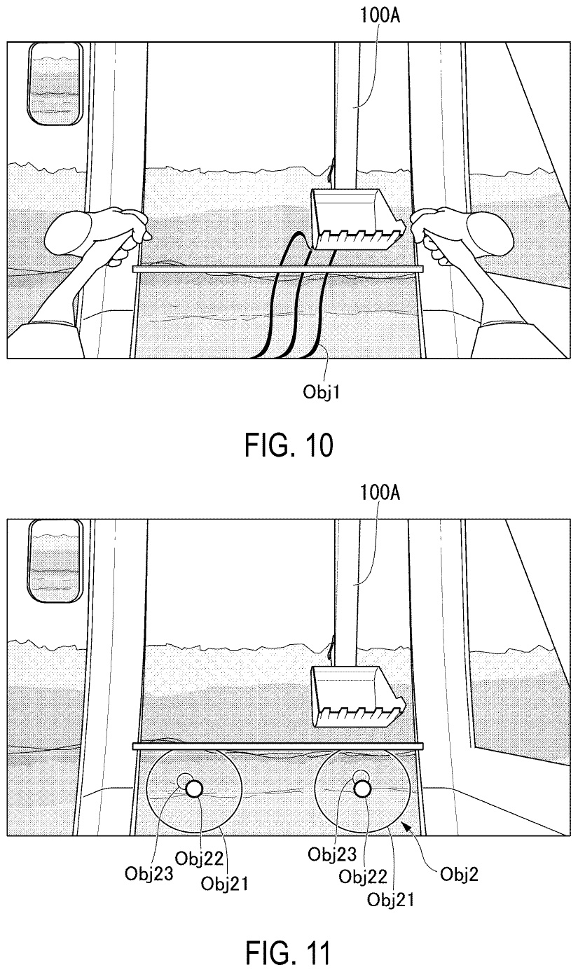

FIG. 11 is an example of the image data when displaying the lever operation of the trainer according to the first exemplary embodiment. The lever objects Obj2 include two reference circles Obj21 representing the left and right operation levers, two operation points Obj22 representing input positions of the left and right operation levers performed by the trainee, and multiple plots Obj23 indicating the positions of lever input performed by the trainer. The two reference circles Obj21 are arranged with a predetermined spacing therebetween in the left-right direction. Each lever object Obj2 is arranged so that its reference circle faces the rendering camera.

Based on the operation data included in the model data, the reproduction unit 313 places the plot Obj23 at a position away from the center of the reference circle Obj21 by the amount of operation performed at the time reproduced in Step S208, and moves the operation point Obj22 to a position away from the center of the reference circle Obj21 by the amount of operation indicated by the operation data acquired in Step S205 (Step S219). In other words, each lever object Obj2 represents changes in the position of the operation lever when the operation lever is viewed from above the operating plane of the operation lever. The reproduction unit 313 reduces the size of the plots Obj23 placed in the past by a predetermined value (Step S220). As a result, the multiple plots Obj23 represent the trajectory of the lever operation over the most recent predetermined period of time. In another exemplary embodiment, the reproduction unit 313 may change the transparency of the plots Obj23 instead of the size of the plots Obj23. Plots Obj23 with transparency below a predetermined threshold value may be removed from the virtual space.

If it is not set to display the lever operation (Step S217: NO), the reproduction unit 313 does not place the lever objects Obj2.

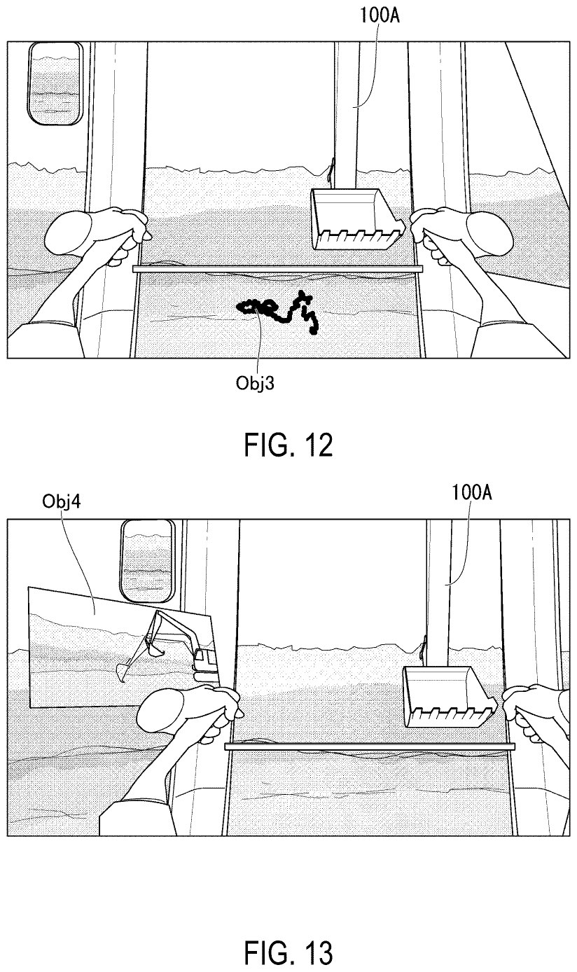

Next, the reproduction unit 313 determines whether or not it is set in the setting data to display trainer's gaze (Step S221). If it is set to display gaze (Step S221: YES), the reproduction unit 313 places gaze objects Obj3 in the virtual space (Step S222). The gaze objects Obj3 are placed at positions a predetermined distance away from the position of the rendering camera determined in Step S207 in the direction indicated by secondary gaze data. Each gaze object Obj3 may be, for example, a small sphere. The reproduction unit 313 increases the transparency of the gaze objects Obj3 placed in the past by a predetermined value (Step S223). As a result, multiple gaze objects Obj3 represent the trainer's gaze trajectory over the most recent predetermined period of time. In another exemplary embodiment, the reproduction unit 313 may change the size and/or hue of the gaze objects Obj3 instead of the transparency. Blade gaze objects Obj3 with transparency exceeding a predetermined threshold value may be removed from the virtual space. For example, if the transparency of the gaze objects Obj3 exceeds the predetermined threshold value, the reproduction unit 313 may not display the gaze objects Obj3. FIG. 12 is an example of the image data when displaying the gaze of the trainee according to the first exemplary embodiment.

If it is not set to display gaze (Step S221: NO), the reproduction unit 313 does not place the gaze objects Obj3 in the virtual space.

Next, the rendering unit 315 determines whether or not it is set in the setting data to display a side view (Step S224). If it is set to display a side view (Step S224: YES), the rendering unit 315 places the rendering camera to a side of the avatar machine 100A so that the rendering camera faces the direction of the avatar machine 100A (Step S225). The rendering unit 315 generates a side view image Obj4 by rendering the virtual space with the avatar machine 100A and the ghost machine 100G placed therein (Step S226). The simulator 314 places the side view image Obj4 at a predetermined position inside the cab 121 (Step S227). FIG. 13 is an example of the image data when displaying the side view according to the first exemplary embodiment.

Next, the rendering unit 315 renders the virtual space with the avatar machine 100A and the ghost machine 100G placed therein, from the rendering camera whose position and posture were found in Step S207 (Step S228). The display control unit 316 outputs the image data rendered in Step S228 to the head-mounted display 35 (Step S229). Since the rendering unit 315 generates image data for each frame time, the image data is treated as frame images of a moving image. It can be said that the rendering unit 315 generates moving image data that simultaneously displays a first moving image presenting the avatar machine 100A and a second moving image presenting the ghost machine 100G, by rendering the virtual space with the avatar machine 100A and the ghost machine 100G placed therein. It can also be said that the rendering unit 315 generates moving image data in which the first moving image with the avatar machine 100A appearing therein and the second moving image with the ghost machine 100G appearing therein are overlaid within the same virtual space.

The generation unit 317 generates secondary gaze data indicating the direction of the trainee's gaze in the virtual space, based on the position and posture of the rendering camera calculated in Step S207 and the primary gaze data acquired in Step S205 (Step S230). The generation unit 317 generates one frame of behavior record data based on the operation data acquired in Step S205, the posture of the avatar machine 100A calculated in Step S206, and the secondary gaze data generated in Step S230 (Step S231).

The generation unit 317 determines whether or not the training has ended (Step S232). For example, the generation unit 317 may determine the training as having ended when a certain amount of time has elapsed since the replay position of the model data reached the end of the time series. If the training has not ended (Step S232: NO), the processing returns to Step S205, and the simulation of the next frame is performed.

On the other hand, if the training has ended (Step S232: YES), the generation unit 317 compiles the generated behavior record data of the multiple frames as work data (Step S233). The evaluation unit 318 calculates evaluation values for evaluating the operation performed by the trainee based on, the differences between the work data generated in step S233 and the model data acquired in Step S203 (Step S234). The transmission unit 319 transmits the work data generated in Step S233, the model ID of the model data acquired in Step S203, and the evaluation values calculated in Step S234 to the data server 10 (Step S235). As a result, the data server 10 assigns a work ID to the received work data, and records the work ID, the work data, the model ID and the evaluation values in association with each other in the work data table T2.

Moreover, the display control unit 316 outputs an evaluation screen that displays the evaluation values calculated in Step S234 to the head-mounted display 35 (Step S236). The evaluation screen may display an evaluation value for each of turning operation, operation of the work equipment 130, and gaze.

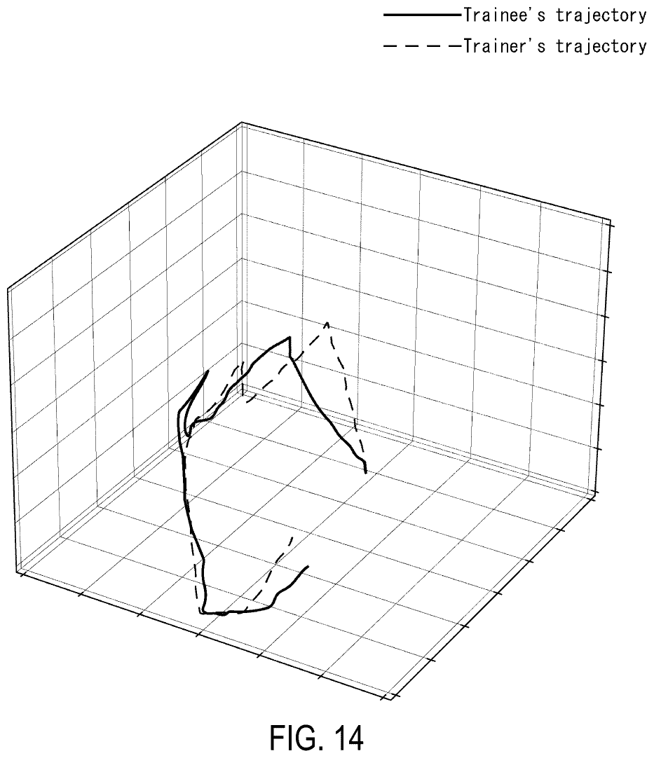

The evaluation unit 318 generates a trajectory model, which is a three-dimensional model in which the trajectory of blade edge movement from the start to the end of training performed through the trainee's operation indicated by the work data and the trajectory of blade edge movement from the start to the end of training performed through the trainer's operation indicated by the model data, are arranged in a three-dimensional space. FIG. 14 is a diagram showing an example of the trajectory model according to the first exemplary embodiment. The display control unit 316 may display the trajectory model generated by the evaluation unit 318 in a rotatable manner on the head-mounted display 35. This enables the display control unit 316 to simultaneously display the trajectory of blade edge movement as operated by the trainee and the trajectory of blade edge movement as operated by the trainer. The trajectory model may be rotated by changing the posture of the head-mounted display 35 or by operating the operation device 33.

### Work Data Evaluation

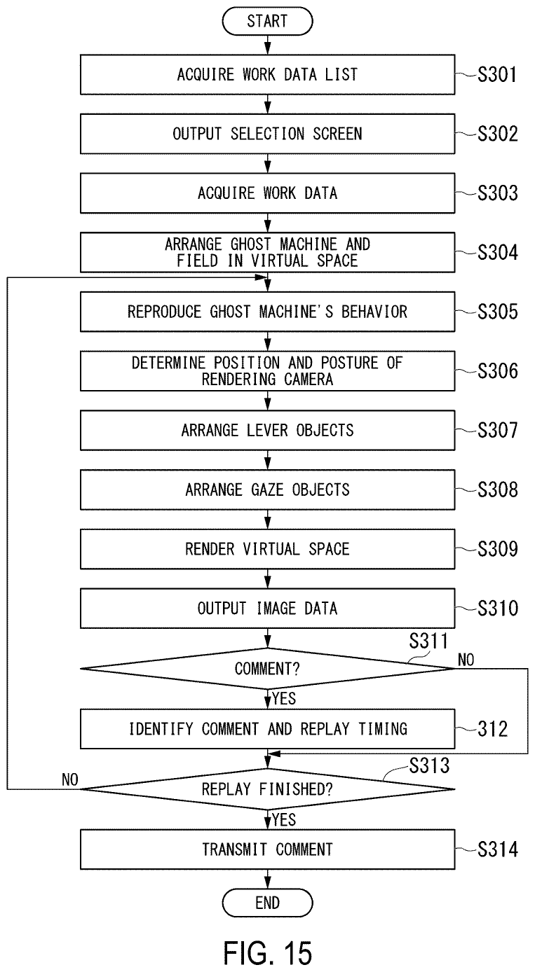

FIG. 15 is a flowchart showing a work data evaluation method according to the first exemplary embodiment.

When the trainer logs into the training simulator 30 and selects to evaluate work data on the menu screen, the acquisition unit 312 accesses the data server 10 and acquires a work data list recorded in the work data table T2 (Step S301). The display control unit 316 outputs a selection screen for selecting one work data from the acquired list, to the head-mounted display 35 (Step S302). The trainer selects one work data.

The acquisition unit 312 accesses the data server 10 and acquires the work data selected by the trainer from the work data table T2 (Step S303). The reproduction unit 313 places the ghost machine 100G and the field in the virtual space (step S304).

The reproduction unit 313 reproduces the behavior of the ghost machine 100G by calculating the posture of the ghost machine 100G based on the time series of the joint angles of the work equipment 130 and the turning angles of the rotating body 120 contained in the work data acquired in Step S303 (Step S305). The reproduction unit 313 calculates the position and posture of the rendering camera in the virtual space based on the position and posture of the rotating body 120 of the ghost machine 100G and the posture data input in Step S305 (Step S306).

The reproduction unit 313 places lever objects Obj2 at positions a predetermined distance away from the position of the rendering camera determined in Step S306 in the direction in which the rendering camera is facing (Step S307). This allows the trainer to check the trainee's lever operation.

The reproduction unit 313 places gaze objects Obj3 in the virtual space (Step S308). The gaze objects Obj3 are placed at positions a predetermined distance away from the position of the rendering camera determined in Step S306 in the direction indicated by secondary gaze data.

The rendering unit 315 renders the virtual space with the ghost machine 100G placed therein, from the rendering camera whose position and posture were found in Step S306 (Step S309). The display control unit 316 outputs the image data rendered in Step S309 to the head-mounted display 35 (Step S310).

The comment section 321 determines whether or not a comment input has been made from the trainer at the current replay timing (Step S311). If a comment input has been made, comment data is generated in which the input comment and the replay timing of the comment are associated (Step S312).

The reproduction unit 313 determines whether or not the replay of the work data has been ended (Step S313). If the replay has not ended (Step S313: NO), the processing returns to Step S305, and the simulation of the next frame is performed.

On the other hand, if the replay has ended (Step S313: YES), the transmission unit 319 transmits the work ID of the work data acquired in Step S303 and the comment data generated in Step S312 to the data server 10 (Step S314). As a result, the data server 10 adds the received comment data to a data string associated with the received work ID in the work data table T2.

### Viewing Evaluation Results

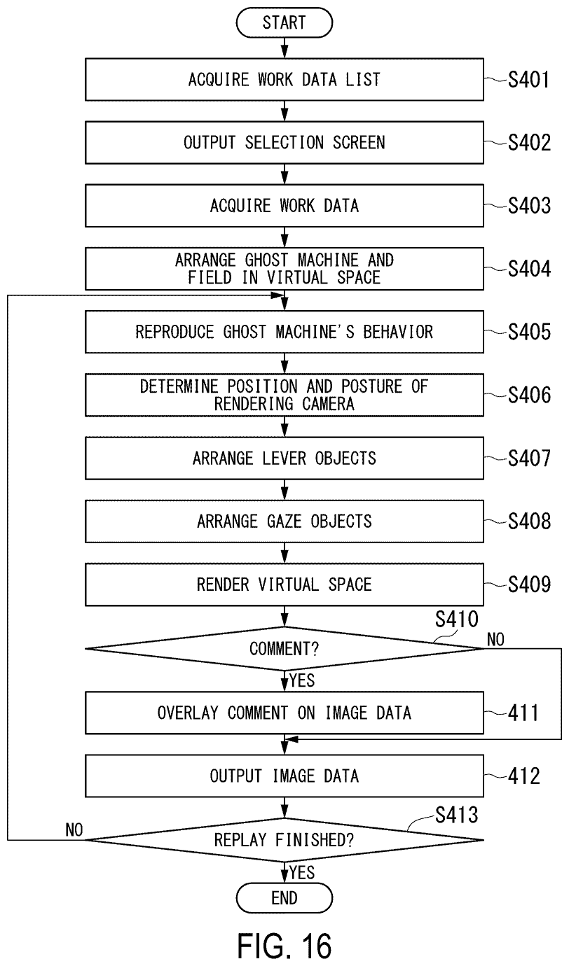

FIG. 16 is a flowchart showing a method according to the first exemplary embodiment by which the trainee views evaluation results.

When the trainee logs into the training simulator 30 and selects to view evaluation value results on the menu screen, the acquisition unit 312 accesses the data server 10 and acquires a work data list recorded in the work data table T2 (Step S401). The list acquired at this time may be a list of work data created by the trainee that is logged in. The display control unit 316 outputs a selection screen for selecting one work data from the acquired list, to the head-mounted display 35 (Step S402). The trainee selects one work data. The acquisition unit 312 accesses the data server 10 and acquires the work data selected by the trainee, from the work data table T2 (Step S403). The reproduction unit 313 places the ghost machine 100G and the field in the virtual space (step S404).

The reproduction unit 313 reproduces the behavior of the ghost machine 100G by calculating the posture of the ghost machine 100G based on the time series of the joint angles of the work equipment 130 and the turning angles of the rotating body 120 contained in the work data acquired in Step S403 (Step S405). The reproduction unit 313 determines the position and posture of the rendering camera in the virtual space based on the position and posture of the rotating body 120 of the ghost machine 100G and the posture data input in Step S405 (Step S406).

The reproduction unit 313 places lever objects Obj2 at positions a predetermined distance away from the position of the rendering camera determined in Step S406 in the direction in which the rendering camera is facing (Step S407). The reproduction unit 313 places gaze objects Obj3 in the virtual space (Step S408).

The rendering unit 315 renders the virtual space with the ghost machine 100G placed therein, from the rendering camera whose position and posture were found in Step S406 (Step S409). The comment unit 321 determines whether or not a comment associated with the current replay timing is present in the comment data contained in the work data (Step S410). If a comment associated with the current replay timing is present (Step S410: YES), the comment is overlaid on the image data being rendered (Step S411). The display control unit 316 outputs the image data rendered in Step S409 or in Step S411 to the head-mounted display 35 (Step S412).

The reproduction unit 313 determines whether or not the replay of the work data has been ended (Step S413). If the replay has not ended (Step S413: NO), the processing returns to Step S405, and the simulation of the next frame is performed. On the other hand, if the replay has ended (Step S413: YES), the training simulator 30 ends the processing.

The training system 1 can also replay work data to which the trainer has not given evaluation, by the procedure shown in FIG. 16. In such a case, since there is no comment, the comment overlaying process in Step S411 is skipped entirely.

### Action and Effect

Thus, the training system 1 according to the first exemplary embodiment executes the following processing. The training system 1 accepts input of first operation data from a trainee, who is a first operator. The training system simulates changes in posture of the avatar machine 100A that is a first work machine in accordance with the first operation data. The training system 1 reproduces the behavior of the ghost machine 100G that is a second work machine, on the basis of model data generated based on second operation data input in the past by a trainer, who is a second operator. The training system 1 simultaneously displays a first moving image representing changes in posture of the avatar machine 100A and a second moving image representing the behavior of the ghost machine 100G.

Thus, the training system 1 allows the trainee to train while comparing their own operation with the operation performed by the trainer. In other words, the first operator and the second operator may be the same operator. By comparing past operation data with current operation data, the same operator can check the degree of improvement in operation or revisit past operations.

The model data for the training system 1 according to the first exemplary embodiment contains time series of postures of the work machine 100 simulated in accordance with the second operation data. This eliminates the need for the training system 1 to perform a simulation using the simulator 314 in order to reproduce the behavior of the ghost machine 100G. That is to say, the training system 1 can reproduce the behavior of the ghost machine 100G by simply changing the posture of the ghost machine 100G according to the posture indicated by the time series. It should be noted that in another exemplary embodiment, the model data may not contain a time series of the posture of the work machine 100, and may be represented by a time series of operation data. In such a case, the training system 1 can reproduce the behavior of the ghost machine 100G by performing a simulation according to the time series of the operation data.

The model data of the training system 1 according to the first exemplary embodiment contains a time series of the trainer's gaze at the time of second operation data input. This allows the training system 1 to present to the trainee not only the method of operating the work machine 100, but also points to which the trainee should pay attention. For example, a point to which attention should be paid is a point of gaze to which attention should be directed when operating the work machine 100.

The training system 1 according to the first exemplary embodiment records work data and comment data from the trainer in association with each other. The training system 1 simultaneously displays a moving image that reproduces the changes in posture of the work machine 100 based on the work data and comment data associated with the work data. This enables the trainee to receive feedback on their own operations from others.

In particular, the training system 1 according to the first exemplary embodiment displays the comment data when the replay timing of the moving image matches the replay timing associated with the comment data. This enables the trainee to recognize which operations, among a series of operations of the work machine 100, require attention.

The training system 1 according to the first exemplary embodiment evaluates the operation of the trainee based on the differences between the first operation data related to the work data and the second operation data related to the model data. This enables the trainee to objectively recognize the extent of the deviation of their operations from the model data.

The training system 1 according to the first exemplary embodiment accepts input of the replay speed of the second moving image related to the model data from the trainee, and simultaneously displays the first moving image showing the avatar machine 100A and the second moving image showing the ghost machine 100G and played at the specified replay speed. As a result, the trainee can perform training suited to their own skill levels. In other words, when the trainee is unfamiliar with an operation, training can be performed at a slower replay speed by running the ghost machine 100G, allowing for careful observation of the trainer's operations. On the other hand, when the trainee becomes more proficient with the operation, training can be performed at a playback speed closer to 1× by running the ghost machine 100G, enabling training that more closely resembles the trainer's actual operation. Moreover, the trainee can perform training under conditions more difficult than those of the actual work machine by operating the ghost machine 100G at a playback speed faster than 1×. In such a case, the trainee will experience an extended sense of time in operating the actual work machine, enabling them to perform more deliberate operations.

The training system 1 according to the first exemplary embodiment executes the following processing. The training system 1 accepts input of first operation data from a trainee, who is a first operator. The training system simulates changes in posture of the avatar machine 100A that is a first work machine in accordance with the first operation data. The training system 1 reproduces the trainer's operations according to the second operation data input in the past by the trainer, who is the second operator. The training system 1 simultaneously displays a first moving image representing changes in the posture of the avatar machine 100A and lever objects Obj2 representing the operations of the trainer. As a result, the trainee can perform a simulation of the work machine 100 while visually checking the operations performed by the trainer. Moreover, according to the first exemplary embodiment, as the lever objects Obj2, operation point Obj22 representing the trainee's lever operations and plots Obj23 representing the trainer's lever operations are displayed simultaneously. As a result, the trainee can perform a simulation of the work machine 100 while visually checking the operations performed by the trainer.

The lever object Obj2 according to the first exemplary embodiment includes a reference circle Obj21 which is a reference position image indicating the reference position of the operation lever, and a plot Obj23 which indicates the position of the operation lever after an operation having been performed. As a result, the trainee can easily recognize the input position of the operation lever based on the positional relationship between the reference circle Obj21 and the plot Obj23.

The lever object Obj2 of the first exemplary embodiment includes multiple plots Obj23, which indicate past positions of the operation lever. These plots Obj23 become smaller or more transparent as they represent older positions. As a result, the trainee can recognize the operation lever's trajectory, and prevent confusion between the current input positions and past input positions of the operation lever.

The lever objects Obj2 according to the first exemplary embodiment are positioned on the front side of the head-mounted display 35 in the gaze direction. As a result, the trainee can visually recognize the operations performed by the trainer regardless of the direction in which they are facing.

The training system 1 according to the first exemplary embodiment executes the following processing. The training system 1 accepts input of first operation data from a trainee, who is a first operator. The training system simulates changes in posture of the avatar machine 100A that is a first work machine in accordance with the first operation data. The training system 1 reproduces the changes in the posture of the ghost machine 100G that is a second work machine, on the basis of model data generated based on second operation data input in the past by the second operator. The training system 1 simultaneously displays a first moving image representing changes in the posture of the avatar machine 100A and a second moving image representing the changes in the posture of the ghost machine 100G. At this time, the initial positions of the avatar machine 100A and the ghost machine 100G match. In other words, the training system 1 displays the avatar machine 100A and the ghost machine 100G superimposed on each other. As a result, the trainee can easily recognize the differences between their own operations and the trainer's operations. For example, the differences in behavior is easier to recognize compared to a case where the avatar machine 100A and the ghost machine 100G are displayed side by side.

The moving image of the avatar machine 100A in the training system 1 according to the first exemplary embodiment is an image in which the avatar machine 100A is rendered from a viewpoint located inside the cab 121 of the avatar machine 100A. The moving image of the ghost machine 100G in the training system 1 according to the first exemplary embodiment is an image in which the ghost machine 100G is rendered from a viewpoint located inside the cab 121 of the avatar machine 100A. This allows the training system 1 to enable the trainee to easily recognize the differences between their own operations and the trainer's operations from the viewpoint within the cab 121 of the avatar machine 100A.

The training system 1 according to the first exemplary embodiment can render only the bucket 133, which is a work tool of the ghost machine 100G. This can prevent the rotating body 120 and boom 131 of the ghost machine 100G from interfering with the avatar machine 100A and deteriorating visibility. Meanwhile, the training system 1 can render the entire ghost machine 100G to enable the trainee to more clearly recognize the differences in the posture between the avatar machine 100A and the ghost machine 100G.

The ghost machine 100G according to the first exemplary embodiment has a transparency higher than that of the avatar machine 100A. As a result, the training system 1 can prevent the ghost machine 100G from interfering with the simulation. The ghost machine 100G according to another exemplary embodiment may have a transparency higher than that of the avatar machine 100A, and may also have a hue value different from that of the avatar machine 100A. This makes it easier to distinguish the ghost machine 100G from the avatar machine 100A. Furthermore, the ghost machine 100G according to another exemplary embodiment may be displayed only by its outline.

The training system 1 according to the first exemplary embodiment executes the following processing. The training system 1 accepts input of first operation data from a trainee, who is a first operator. The training system simulates changes in posture of the avatar machine 100A that is a first work machine in accordance with the first operation data. The training system 1 reproduces the changes in the posture of the ghost machine 100G that is a second work machine, on the basis of model data generated based on second operation data input in the past by the second operator. The training system 1 simultaneously displays the avatar machine 100A and blade edge objects Obj1 that represent the trajectory of the bucket 133, which is a work tool of the ghost machine 100G. As a result, the trainee can easily recognize the differences between their own operations and the trainer's operations.

The training system 1 according to the first exemplary embodiment places blade edge objects Obj1 corresponding to each of the multiple points on the blade edge. Each blade edge object Obj1 represents the trajectory of each of the points. By providing the blade edge objects Obj1 at multiple points on the blade edge, the trainee can easily recognize the depth-wise position of the bucket cutting edge 133.

The color of the blade edge object Obj1 in the first exemplary embodiment varies for each of the multiple points. As a result, the likelihood of confusion and misrecognition of the multiple blade edge objects Obj1 can be reduced.

The training system 1 according to the first exemplary embodiment executes the following processing. The training system 1 accepts input of operation data from an operator. The training system 1 detects a gaze of the operator during input of the operation data. The training system 1 simulates a change in the posture of the work machine 100 in accordance with the operation data. The training system 1 simultaneously displays a posture image representing a simulated change in the posture of the work machine 100 and a gaze object Obj3 representing changes in the gaze. As a result, the training system 1 enables an operator to display the relationship between the operation of the work machine 100 and the gaze of the operator. As a result, the trainee can recognize the points that require attention during operation, based on the trainer's gaze. This also allows the trainer to evaluate the trainee's operation based on the trainee's gaze.

In the first exemplary embodiment, the blade edge object Obj1, the plot Obj23 of the lever object Obj2, and the gaze object Obj3 are multiple points that represent trajectories. On the other hand, in another exemplary embodiment, some or all of these objects may be curves that represent trajectories.

### SECOND EXEMPLARY EMBODIMENT

In the training system 1 according to the first exemplary embodiment, the behavior of the ghost machine 100G is continuously reproduced at a replay speed specified in the setting data. On the other hand, in the case where the trainee is a beginner, there is a possibility that their operation may lag behind the behavior of the ghost machine 100G. In such a case, if the ghost machine 100G is continuously reproduced and the postures of the avatar machine 100A and the ghost machine 100G differ significantly, the trainee may lose track of the indicators for operation. The training system 1 according to a second exemplary embodiment enables appropriate training to be performed even in the case where the trainee's operations are slow.

As shown in FIG. 5, the training system 1 according to the first exemplary embodiment reproduces the behavior of the ghost machine 100G for each frame time in Step S208. In contrast, in the second exemplary embodiment, the following process is executed instead of Step S208.

The reproduction unit 313 calculates the distance between the posture of the avatar machine 100A calculated in Step S206 and the previous posture of the ghost machine 100G. The distance between postures can be determined, for example, by finding the root mean square of the differences in turning angle, boom angle, arm angle, and bucket angle. If the calculated distance exceeds a threshold value previously set in the setting data, the reproduction unit 313 maintains the posture of the ghost machine 100G. On the other hand, if the calculated distance does not exceed the threshold value previously set in the setting data, the reproduction unit 313 reproduces the behavior of the ghost machine 100G by calculating the posture of the ghost machine 100G based on the time series of the joint angles of the work equipment 130 and the turning angle of the rotating body 120 contained in the model data, and the replay speed of the ghost machine 100G indicated by the setting data.

Thus, according to the second exemplary embodiment, the training system 1 stops reproduction of the behavior of the ghost machine 100G in the case where the difference between the simulated posture of the avatar machine 100A and the posture of the ghost machine 100G exceeds a predetermined threshold value. For example, when the training system 1 stops reproduction of the behavior of the ghost machine 100G, the training system 1 may store an image of the moment at which the reproduction is stopped. As a result, the training system 1 according to the second exemplary embodiment enables appropriate training to be performed even in the case where the trainee's operations are slow.

### OTHER EXEMPLARY EMBODIMENTS

The exemplary embodiments of the present invention have been described in detail with reference to the drawings. However, the specific configuration of the invention is not limited to the exemplary embodiments described above, and various design changes may be made thereto. That is to say, in another exemplary embodiment, the order of the processes described above may be changed where appropriate. Furthermore, some of the processes may be executed in parallel.

The training system 1 according to the exemplary embodiments described above includes a data server 10 and multiple training simulators 30, however, the invention is not limited to these configurations. For example, the training system 1 according to another exemplary embodiment may be configured with the training simulator 30 alone. In such a case, training can be performed using model data that has been pre-recorded in the training simulator 30. Moreover, the training system 1 according to another exemplary embodiment may allow the trainee to perform training while referencing work data from their past operations. In another exemplary embodiment, a portion of the training simulator 30 may be provided in an external computer. For example, in another exemplary embodiment, the training simulator 30 may only be responsible for inputting operation data and displaying the calculation results, and the simulation calculations may be performed by an external device.

The training system 1 according to the exemplary embodiment described above uses the head-mounted display 35 as a display device, however, the invention is not limited to this configuration. For example, in another exemplary embodiment, a large display used for remote operation of the work machine 100 may be used as the display device. At this time, the input unit 311 may accept designation of the position and posture of the rendering camera from the operator. Examples of the position and posture of the rendering camera include a subjective viewpoint (operator's viewpoint), an objective viewpoint (diagonally behind the operator), an overhead viewpoint (to the side of the work machine 100), and a free viewpoint. The rendering unit 315 renders the virtual space according to the specified position and posture of the rendering camera. Moreover, the display control unit 316 may accept instructions to replay (start over) or pause when replaying work data. The display control unit 316 may also display a seek bar indicating the replay position and accept an instruction to cue to an arbitrary point by operating the seek bar.

### COMPUTER CONFIGURATION

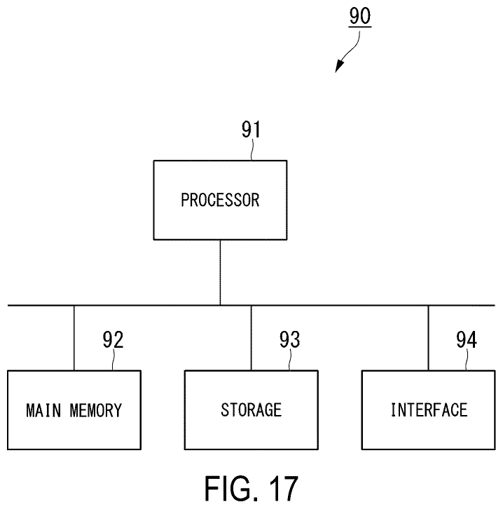

FIG. 17 is a schematic block diagram showing a configuration of a computer according to at least one of the exemplary embodiments.

A computer 90 includes a processor 91, a main memory 92, a storage 93, and an interface 94.

The training simulator 30 described above is implemented in the computer 90. The operation of each processing unit described above is stored in the storage 93 in the form of a program. The processor 91 reads out the program from the storage 93, loads it onto the main memory 92, and executes the processes described above according to the program. Moreover, the processor 91 secures, according to the program, memory storage regions corresponding to the respective storage units mentioned above, in the main memory 92. Examples of the processor 91 include a CPU (Central Processing Unit), a GPU (Graphics Processing Unit), and a microprocessor.

The program may be a program for realizing some of the functions exerted by the computer 90. For example, the program may exert the functions in combination with another program already stored in the storage, or in combination with another program implemented on another device. It should be noted that, in another exemplary embodiment, the computer 90 may include a custom LSI (Large Scale Integrated Circuit) such as a PLD (Programmable Logic Device) in addition to or in place of the above configuration. Examples of PLDs include PAL (Programmable Array Logic), GAL (Generic Array Logic), CPLD (Complex Programmable Logic Device), and FPGA (Field Programmable Gate Array). In such a case, some or all of the functions realized by the processor 91 may be realized by an integrated circuit. Such an integrated circuit is also an example of the processor. Also, in another exemplary embodiment, the computer 90 may be virtualized on multiple computers.

Examples of the storage 93 include a magnetic disk, a magneto-optical disk, an optical disk, and semiconductor memory. The storage 93 may be an internal medium directly connected to the bus of the computer 90, or an external medium connected to the computer 90 via the interface 94 or a communication line. In the case where this program is distributed to the computer 90 via a communication line, the computer 90 which has received the program distribution may load the program onto the main memory 92 and may execute the above processes. In at least one of the exemplary embodiments, the storage 93 is a non-transitory tangible storage medium.

Moreover, this program may be a program for realizing some of the functions described above. Also, the program may be a so-called difference file (a difference program) which realizes the functions described above in combination with another program already stored in the storage 93.

### INDUSTRIAL APPLICABILITY

According to the above aspect, it is possible to easily compare an operator's operation with another operation, in training for operating a work machine.

### REFERENCE SIGNS LIST

1 Training system
10 Data server
100 Work machine
100A Avatar machine
100G Ghost machine
110 Traveling body
120 Rotating body
121 Cab
130 Work equipment
131 Boom
132 Arm
133 Bucket
30 Training simulator
31 Computing device
311 Input unit
312 Acquisition unit
313 Reproduction unit
314 Simulator
315 Rendering unit
316 Display control unit
317 Generation unit
318 Evaluation unit
319 Transmission unit
320 Setting memory unit
321 Comment unit
322 Authentication unit
33 Operation device
35 Head-mounted display
90 Computer
91 Processor
92 Main memory
93 Storage
94 Interface
Obj1 Blade edge object
Obj2 Lever object
Obj21 Reference circle
Obj23 Plot
Obj3 Gaze object
Obj4 Side view image
T1 Model data table
T2 Work data table
T3 User table
V Virtual space

1. A display system for a work machine, comprising:
a hardware processor configured to:
accept input of first operation data from a first operator,
simulate a change in posture of a work machine in accordance with the first operation data,
reproduce an operation performed by a second operator, on the basis of model data including second operation data previously input by the second operator, and
simultaneously display a first moving image representing the simulated change in the posture of the work machine and a second moving image representing the reproduced operation performed by the second operator.

2. The display system according to claim 1, wherein the hardware processor is configured to:
reproduce a behavior of the work machine on the basis of the model data,
wherein the second moving image includes the reproduced operation performed by the second operator and the reproduced behavior of the work machine, and
the first moving image and the second moving image are displayed in an overlaid manner.

3. The display system according to claim 2, wherein
the second moving image includes a reference position image indicating a reference position of an operation lever, and an input position image indicating a position of the operating lever after operation.

4. The display system according to claim 3, wherein
the first moving image includes the input position image indicating the position of the operation lever of the first operation data, performed by the first operator.

5. The display system according to claim 3, wherein
the second moving image includes a plurality of past position images showing past positions of the operation lever, and the past position images that are older are smaller in size or have higher transparency.

6. The display system according to claim 1, wherein
the second moving image represents a change in a position of the operation lever when the operation lever is viewed from above an operating plane of the operation lever.

7. The display system according to claim 1, wherein
the first moving image and the second moving image are displayed on a head-mounted display, and
the second moving image is positioned forward in a gaze direction, on the head-mounted display.

8. A display method to be executed by a computer, the display method comprising
accepting input of first operation data from a first operator,
simulating a change in posture of a work machine in accordance with the first operation data,
reproducing an operation performed by a second operator, on the basis of model data including second operation data previously input by the second operator, and
simultaneously displaying a first moving image representing the simulated change in the posture of the work machine and a second moving image representing the reproduced operation performed by the second operator.
